(19) United States
(12) Patent Application Publication
(10) Pub. No.: US 2014/0164574 A1
(43) Pub. Date: Jun. 12, 2014

(54) Method and System for Downloading a Font File

(71) Applicants: Beijing Founder Electronics Co., Ltd., Beijing (CN); Peking University Founder Group Co., Ltd., Beijing (CN)

(72) Inventors: Yujun Gao, Beijing (CN); Fang Liu, Beijing (CN)

(21) Appl. No.: 14/130,664

(22) PCT Filed: Dec. 31, 2012
(86) PCT No.: PCT/CN2012/088054

§ 371 Date: Jan. 2, 2014

(30) Foreign Application Priority Data
Dec. 31, 2011 (CN) 201110460619.7

(51) Int. Cl. H04L 29/08

(52) U.S. Cl. CPC H04L 67/06
USPC 709/219

(57) ABSTRACT

Disclosed is a method and system for downloading a font file. This can be used when a user cannot download a font file from a file server when the size of the font file exceeds the gateway limit corresponding to the user. The method includes: splitting the font file into a plurality of sub font files each having a size no larger than the gateway transmission limit threshold, and if the size of the font file to be downloaded by a user device is greater than the gateway transmission limit threshold corresponding to the user device, sending all sub font files to the user device.

### FIELD OF THE INVENTION

The present invention relates to the field of computer technology, and particularly, to a method and a system for downloading a font file.

### BACKGROUND OF THE INVENTION

The development of the embedded technology and the popularity of embedded electronic devices make it possible to access to a needed service by accessing a wireless network. However, a network provider or operator that provides a service usually imposes a limit on size of a file transmitted wirelessly via its corresponding gateway, so as to prevent a user device from occupying network bandwidth resources for too long a time, such that the limited bandwidth resources may provide service to as many user devices as possible. For example, a Wireless Application Protocol (WAP) gateway will intercept files with a size larger than the gateway limit.

A font library is an electronic text font collection library of foreign language character font, Chinese character font and related character fonts and is widely used in computers, networks and related electronic devices (such as a mobile phone, a tablet computer and the like). A user may download a font file from a file server via the WAP gateway using a user device and have the downloaded file installed for use. However, font files are generally of large sizes. As the WAP gateway imposes a limit on the size of files transmitted wirelessly, the WAP gateway will intercept a font file in the case that the size of the font file exceeds the limit of the WAP gateway, which makes it impossible for user devices to obtain a needed font file from the file server via the WAP gateway.

To sum up, the user cannot download the font file from the file server when the size of the font file to be downloaded is larger than the limit of the gateway corresponding to the user.

### SUMMARY OF THE INVENTION

The present invention provides a method and a system for downloading a font file which can be used for solving the problem in the prior art that a user cannot download a needed font file from a file server when the size of the font file to be downloaded is larger than the limit of a gateway corresponding to the user.

The invention provides a method for downloading a font file, comprising:

splitting a font file to be downloaded by a user device into a plurality of sub font files each having a size no larger than a transmission limit threshold of a gateway corresponding the user device, if a size of the font file is larger than the transmission limit threshold of the gateway; and

transmitting all of the sub font files to the user device.

Preferably, splitting the font file comprises:

splitting glyph outline data in the font file to obtain the plurality of sub font files each comprising a part of the glyph outline data and having a size no larger than the transmission limit threshold, if a size of the glyph outline data is larger than the transmission limit threshold; and

splitting data other than the glyph outline data in the font file to obtain the plurality of sub font files each comprising a part of the data other than the glyph outline data and having a size no larger than the transmission limit threshold, if a size of the data other than the glyph outline data is larger than the transmission limit threshold; taking the data other than the glyph outline data in the font file as a single sub font file if a size of the data other than the glyph outline data is no larger than the transmission limit threshold.

Preferably, splitting the font file comprises:

splitting glyph outline data in the font file to obtain the plurality of sub font files each comprising a part of the glyph outline data, if a size of data other than the glyph outline data in the font file is no larger than the transmission limit threshold; and

for each sub font file of the plurality of sub font files, putting all data other than the glyph outline data into the sub font file, wherein a size of the sub font file is not larger than the transmission limit threshold.

The method for downloading a font file further comprises:

downloading all of the sub font files to the user device; and

processing all of the sub font files by the user device to obtain a usable font file.

Preferably, processing all of the sub font files by the user device comprises:

combining all sub font files each comprising the part of glyph outline data and all sub font files comprising data other than the glyph outline data to obtain the usable font file, if the sub font files each comprising the part of glyph outline data do not comprise the data other than the glyph outline data; or

for each sub font file comprising the part of glyph outline data, combining the sub font file with all sub font files comprising data other than the glyph outline data to obtain the usable font file, if the sub font files each comprising the part of glyph outline data do not comprise the data other than the glyph outline data.

Preferably, processing all of the sub font files by the user device comprises:

taking each of the downloaded sub font files as a single usable font file, if the sub font file comprising the glyph outline data comprises all data other than the glyph outline data.

The present invention provides a system for downloading a font file, comprising:

a server for splitting a font file to be downloaded by a user device into a plurality of sub font files each having a size no larger than a transmission limit threshold of a gateway corresponding the user device, when a size of the font file is larger than the transmission limit threshold of the gateway; and transmitting all of the sub font files to the user device; and

the user device for downloading all of the sub font files; and processing all of the sub font files to obtain a usable font file.

Preferably, the user device is further adapted for transmitting a download request to the sever via the corresponding gateway to obtain the font file to be downloaded; and

the server is further adapted for, upon receipt of the download request transmitted by the user device, determining the gateway corresponding to the user device according to identification (ID) information of the user device, thereby determining the transmission limit threshold of the gateway; and for determining the font file to be downloaded according to the download request transmitted by the user device, and determining whether to split the font file according to a relationship between the size of the font file and the transmission limit threshold.

Preferably, the ID information of the user device comprises at least one of an International Mobile Equipment Identification Number (IMEI), an International Mobile Subscriber Identification Number (IMSI), a Mobile Station Directory Number (MSDN) and a Subscriber Identity Module (SIM).

Preferably, the server comprises:

a split processing module for splitting the font file to be downloaded by the user device into the plurality of sub font files each having a size no larger than the transmission limit threshold of the gateway corresponding the user device, when the size of the font file is larger than the transmission limit threshold of the gateway; and

a transmission module for transmitting all of the sub font files to the user device.

Preferably, the split processing module is adapted for:

determining a splitting unit of the font file to be downloaded according to the transmission limit threshold of the gateway corresponding to the user device when the size of the font file to be downloaded is larger than the transmission limit threshold, and splitting the font file according to the splitting unit to obtain a plurality of sub font files each having a size no larger than the transmission limit threshold, wherein the splitting unit is a size of a sub font file obtained with a single splitting and a size of the splitting unit is not larger than the transmission limit threshold.

Preferably, the split processing module is further adapted for determining the number of the sub font files according to the splitting unit and for creating a plurality of blank files, and sequentially copying data in the font file to a corresponding one of the plurality of blank files according to the size of the splitting unit, thereby obtaining the plurality of sub font files each having a size no larger than the transmission limit threshold, wherein the number of the blank files is the same as the number of the sub font files.

Preferably, the split processing module is further adapted for sequentially splitting the data in the font file according to the size of the splitting unit to obtain the plurality of sub font files each having a size no larger than the transmission limit threshold, without retaining the font file.

Preferably, the split processing module is further adapted for determining naming rules for the sub font files;

the transmission module is further adapted for transmitting the naming rules for the sub font files to the user device; and

the user device is further adapted for, after downloading all of the sub font files and the naming rules for the sub font files, determining an order for all of the sub font files according to the naming rules for the sub font files, and combining all of the sub font files in a manner that a next sub font file is appended to the end of a previous font file one by one according to the order, thereby obtaining the usable font file.

Preferably, the split processing module is further adapted for determining naming rules for the sub font files and for creating an index file for the font file to be downloaded, the index file comprises the size of the font file, the splitting unit and the naming rules for the sub font files;

the transmission module is further adapted for transmitting the index file to the user device; and

the user device is further adapted for, after downloading all of the sub font files and the index file, determining a file name of each sub font file that needs to be downloaded according to the index file, and creating corresponding blank files for sequentially storing the sub font files downloaded from the transmission module; during the procedure of downloading the sub font files, an offset amount of each sub font file starts from zero and a downloading offset amount of a currently being downloaded sub font file is recorded in real time, so as to facilitate combining the downloaded sub font files to obtain the usable font file.

Preferably, the user device is further adapted for:

during the procedure of downloading the sub font files, if a connection with the server is disconnected and downloading needs to continue after a normal connection with the server is recovered, first obtaining a total size of the downloaded sub font files, and then carrying out calculations based on the total size of the downloaded sub font files and the splitting unit of the font file to be downloaded to set the sub font files to be downloaded subsequently, and transmitting a request for renewing downloading thereby resuming the downloading.

Preferably, the user device is further adapted for:

reading the index file for the font file to be downloaded to determine the size and the splitting unit of the font file and sequentially determining a size of each of the downloaded sub font files to determine whether the downloaded sub font files are complete;

for each of the downloaded sub font files, determining that the sub font file has been downloaded completely, if the size of the sub font file is not zero and the size of the sub font file is the same as an actual size of the corresponding sub font file in the server; and

offsetting a pointer for the corresponding sub font file in the server by an amount corresponding to the size of the sub font file has been downloaded by the user device, if the size of the sub font file is smaller than the actual size of the corresponding sub font file in the server, a remaining size of the sub font file to be downloaded is a difference between the actual size of the corresponding sub font file in the server and the locally downloaded size of the sub font file.

Preferably, the split processing module is adapted for:

when the size of the font file to be downloaded by the user device is larger than the transmission limit threshold of the gateway corresponding to the user device,

if the size of the glyph outline data in the font file is not lager than the transmission limit threshold, and the size of the data other than the glyph outline data in the font file is not larger than the transmission limit threshold,
splitting the font file to obtain a single sub font file comprising the glyph outline data in the font file and a single sub font file comprising the data other than the glyph outline data in the font file, or
splitting the font file to obtain a plurality of sub font files each comprising a part of the glyph outline data in the font file and the data other than the glyph outline data in the font file;

if the size of the glyph outline data in the font file is lager than the transmission limit threshold, and the size of the data other than the glyph outline data in the font file is not larger than the transmission limit threshold,
splitting the font file to obtain a single sub font file comprising the data other than the glyph outline data in the font file and a plurality of sub font files each having a size no larger than the transmission limit threshold and comprising a part of the glyph outline data in the font file, or
splitting the font file to obtain a plurality of sub font files each having a size no larger than the transmission limit threshold and comprising a part of the glyph outline data in the font file and the data other than the glyph outline data in the font file;

if the size of the glyph outline data in the font file is lager than the transmission limit threshold, and the size of the data other than the glyph outline data in the font file is also larger than the transmission limit threshold, splitting the font file to obtain a plurality of sub font files each having a size no larger than the transmission limit threshold and comprising a part of the glyph outline data in the font file and a plurality of sub font files each having a size no larger than the transmission limit threshold and comprising a part of the data other than the glyph outline data in the font file; and

if the size of the glyph outline data in the font file is not lager than the transmission limit threshold, and the size of the data other than the glyph outline data in the font file is larger than the transmission limit threshold, splitting the font file to obtain a single sub font file comprising the glyph outline data in the font file and a plurality of sub font files each having a size no larger than the transmission limit threshold and comprising a part of the data other than the glyph outline data in the font file.

Preferably, the split processing module is further adapted for, when splitting the font file to obtain the sub font files each comprising the part of the glyph outline data in the font file, splitting the glyph outline data in the font file according to international Character encoding, ID serial number or Chinese national standard corresponding to each glyph outline data and establishing splitting rules;

the transmission module is further adapted for transmitting the splitting rules to the user device; and

the user device is further adapted for combining all of the sub font files according the splitting rules to obtain the usable font file, after downloading all of the sub font files.

Preferably, the user device comprises:

a downloading module for downloading all of the sub font files; and

a processing module for processing all of the sub font files to obtain the usable font file.

Preferably, the processing module is adapted for:

if a sub font file comprising a part of glyph outline data does not comprise data other than the glyph outline data,
combining all of the sub font files each comprising the part of the glyph outline data and all of the sub font files comprising the data other than the glyph outline data to obtain the usable font file; or
for each of the sub font files each comprising the part of glyph outline data, combining the sub font file with all the sub font files comprising the data other than the glyph outline data to obtain a single usable font file; and

if a sub font file comprising the glyph outline data comprises data other than the glyph outline data, taking each of the downloaded sub font files as a single usable font file.

Preferably, the server further comprises:

a determination module for determining whether the size of the font file to be downloaded by the user device is larger than the transmission limit threshold of the gateway corresponding to the user device,

the determination module causes the split processing module to work, when the size of the font file is larger than the transmission limit threshold; and

the determination module causes the transmission module to transmit the font file directly to the user device, when the size of the font file is not larger than the transmission limit threshold.

Preferably, the server further comprises a compression processing module,

the compression processing module is adapted for compressing the font file when the determination module determines that the size of the font file is larger than the transmission limit threshold and before the determination module causes the split processing module to work, and for causing the determination module to work again after the compression processing;

the determination module is further adapted for determining once again whether the size of the compressed font file is larger than the transmission limit threshold of the gateway corresponding to the user device, after being caused to work by the compression processing module, and for causing the split processing module to work, when the size of the compressed font file is larger than the transmission limit threshold; and causing the transmission module to transmit the compressed font file directly to the user device, when the size of the compressed font file is not larger than the transmission limit threshold; and

the user device is further adapted for, after downloading all of the sub font files, processing all of the sub font files to obtain a usable compressed font file; the user device comprises a decompression processing module, which is adapted for decompressing the compressed font file to obtain the usable font file.

According to the present invention, the font file to be downloaded is split into a plurality of sub font files each having a size no larger than a transmission limit threshold of the gateway corresponding to the user device when the size of the font file to be downloaded is larger than the transmission limit threshold, and during downloading, the user device downloads and processes each of the sub font file separately to obtain a usable font file. It thus avoids the situation that the user cannot download the font file to be downloaded from the file server when the size of the font file exceeds the limit of the gateway corresponding to the user.

### BRIEF DESCRIPTION OF THE DRAWINGS

FIG. 1 is a schematic configuration of a first system for downloading a font file in accordance with an embodiment of the present invention;

FIG. 2 is a schematic configuration of a first server in accordance with an embodiment of the present invention;

FIG. 3 is a schematic configuration of a second server in accordance with an embodiment of the present invention;

FIG. 4 is a flow chart of a first method for downloading a font file in accordance with an embodiment of the present invention;

FIG. 5 is a schematic configuration of a first user device in accordance with an embodiment of the present invention;

FIG. 6 is a schematic configuration of a second user device in accordance with an embodiment of the present invention;

FIG. 7 is a flow chart of a second method for downloading a font file in accordance with an embodiment of the present invention;

FIG. 8 is a schematic configuration of a second system for downloading a font file in accordance with an embodiment of the present invention; and

FIG. 9 is a flow chart of a third method for downloading a font file in accordance with an embodiment of the present invention.

### DETAILED DESCRIPTION OF EMBODIMENTS

According to an embodiment of the present invention, a font file to be downloaded is split into a plurality of sub font files each having a size no larger than a transmission limit threshold of the gateway corresponding to the user device when the size of the font file to be downloaded is larger than the transmission limit threshold, and during downloading, the user device downloads and processes each of the sub font files separately to obtain a usable font file. It thus solves the problem that the user cannot download the font file from the file server when the size of the font file to be downloaded by the user exceeds the limit of the gateway corresponding to the user.

In the following, embodiments of the present invention will be described in detail with reference to the drawings.

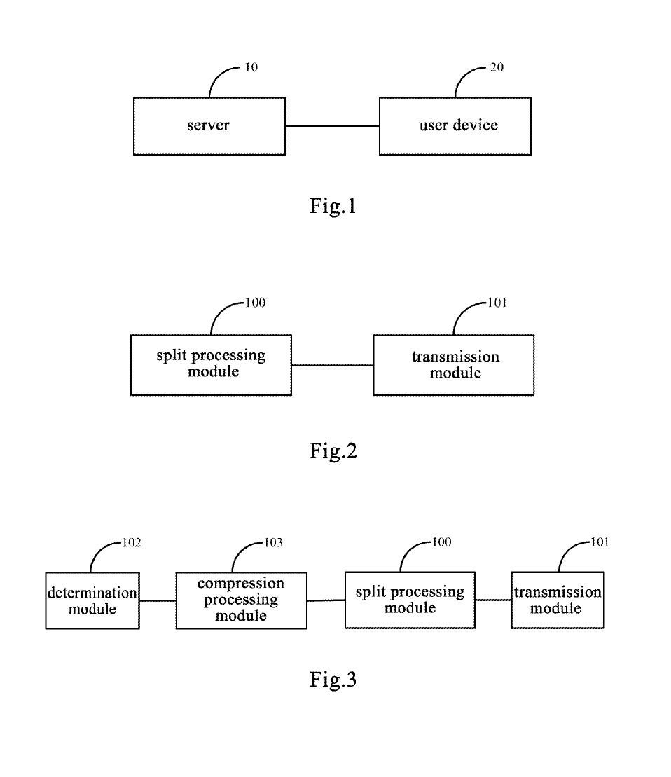

As illustrated in FIG. 1, an embodiment of the present invention provides a system for downloading a font file, comprising: a server 10 for splitting a font file to be downloaded by a user device 20 into a plurality of sub font files each having a size no larger than a transmission limit threshold of a gateway corresponding the user device, when a size of the font file is larger than the transmission limit threshold of the gateway, and transmitting all of the sub font files to the user device 20; and the user device 20 for downloading all of the sub font files and processing of all of the sub font files to obtain a usable font file.

The user device 20 in accordance with an embodiment of the present invention may be an embedded electronic device such as a mobile phone, a tablet computer and the like. The user device 20 transmits a download request to the server 10 via its corresponding WAP gateway as needed so as to download and install the needed font file for use, wherein the WAP gateway is adapted for connecting a wireless network and the Internet and may implement functions such as conversions of wireless application protocol (WAP) stack as well as conversion of content format (for example, from Wireless Markup Language (WML) to Hypertext Markup Language (HTML)).

Furthermore, a Chinese character font file among font files is generally of a relatively large size. Some extra large Chinese character font files may have a data size of up to hundreds of Mb, while the gateway generally imposes a limit on the size of files transmitted wirelessly via the gateway so as to prevent a user device from occupying the network bandwidth resources for too long a time.

Upon receipt of the download request transmitted by the user device 20, the server 10 determines the WAP gateway corresponding to the user device 20 according to ID information of the user device 20, e.g. a characteristic parameter that may determine the gateway corresponding to the user device such as an International Mobile Equipment Identification Number (IMEI), an International Mobile Subscriber Identification Number (IMSI), a Mobile Subscriber International ISDN/PSTN Number (MSISDN) or a Subscriber Identity Module (SIM) card, thereby determining the transmission limit threshold of the WAP gateway, and determines the font file to be downloaded according to the download request transmitted by the user device 20. A server storing the font files and the server processing the font file to be downloaded may be the same server or two separate servers that may interact with each other.

After determining the font file to be downloaded and the transmission limit threshold of the gateway corresponding to the user device 20, the server 10 determines whether a size of the font file is larger than the transmission limit threshold.

If the size of the font file is larger than the transmission limit threshold, the font file is first split into a plurality of sub font files each having a size no larger than a transmission limit threshold and then each of the sub font files is transmitted to the user device 20. Accordingly, after downloading all of the sub font files from the server 10 via the gateway, the user device 20 processes all of the sub font files according to different ways of splitting performed by the server 10 to obtain a usable font file, such that the font file may be used on the user device 20.

If the size of the font file is not larger than the transmission limit threshold, the font file is transmitted to the user device 20 directly. Accordingly, after being downloaded from the server 10 by the user device 20 via the gateway, the font file may be used on the user device 20.

According to the embodiment of the present invention, upon receipt of the download request transmitted by the user device, the server first determines the gateway corresponding to the user device according to the ID information of the user device and then determines the transmission limit threshold corresponding to the gateway, and determines the font file to be downloaded according to the download request. The server then determines whether to split the font file according to the relationship between the size of the font file and the transmission limit threshold. Instead of splitting all of the font files stored on the server, a font file is split only when the size of this font file is larger than the transmission limit threshold, thereby saving the storage space, improving the efficiency of the server and avoiding the situation that the user device cannot download the font file when the size of the font file exceeds the transmission limit threshold. As user devices need to download font files from the server may correspond to different gateways and each gateway may have different transmission limit thresholds, the server according to the embodiment of the present invention determines whether to split the font file in real time according to the transmission limit threshold of the gateway corresponding to each user device, thereby improving the efficiency of the server.

As illustrated in FIG. 2, the server 10 according to the embodiment of the invention comprises: a split processing module 100 for splitting the font file to be downloaded by the user device 20 into the plurality of sub font files each having a size no larger than the transmission limit threshold of the gateway corresponding the user device 20, when the size of the font file is larger than the transmission limit threshold of the gateway; and a transmission module 101 for transmitting all of the sub font files to the user device 20.

When the size of the font file to be downloaded by the user device 20 is larger than the transmission limit threshold of the gateway corresponding to the user device 20, the split processing module 100 of the server 10 is caused to split the font file. A detail split processing comprises the following two methods.

Method 1: sequentially splitting data in the font file into a plurality of sub font files each having a size no larger than the transmission limit threshold.

Specifically, description will be made by taking gateway cmwap of China Mobile as an example of the gateway corresponding to the user device 20. The gateway cmwap usually limits the size of each file to be downloaded to be not larger than 1 M (1024*1024 byte), that is, the transmission limit threshold of the gateway cmwap is 1 M. When the size of the file to be downloaded is larger than 1 M, the gateway cmwap normally will block the download, making it impossible for the user device 20 to download the file from the server 10. It is assumed that the user device 20 needs to download a font file, which is hypothetically named F, from the server 10, the split processing module 100 determines a splitting unit of the font file (which is not larger than the transmission limit threshold) and a naming rule (e.g., to sequentially name the sub font files as F₁, F₂, . . . ) of the sub font files, according to the transmission limit threshold, so as to determine the number of the sub font files. Here the splitting unit is the size of a sub font file obtained with a single splitting. Please note that the last sub font file being split may have a size smaller than the splitting unit, and sub font files other than the last sub font file are of a size equal to the splitting unit.

Assuming that the splitting unit is 819200 bytes (800*1024) and the font file is split into nine sub font files according to the size of the font file and the splitting unit, the split processing module 100 may create nine blank files during the splitting process, and then copy 819200 bytes starting from the first byte of the font file and paste the 819200 bytes to the first blank file as the first sub font file F₁. The split processing module 100 then copies 819200 bytes starting from the 819201th byte to the second blank file as the second sub font file F₂, and so on. This splitting method retains the original font file such that the server 10 may transmit the font file or all of the sub font files to the user device 20 as needed. Splitting may also be performed on the original font file directly in an incremental way without retaining the original file, thereby saving the storage space of the server 10.

Accordingly, upon receipt of all nine sub font files F₁˜F₉, the user device 20 may determine an order for all of the sub font files according to the naming rules for the sub font files and combine all nine sub font files F₁˜F₉ in a manner that a next sub font file is appended to the end of a previous font file one by one (That is, the sub font file F₂ is appended to the end of the sub font file F₁, and the sub font file F₃ is appended to the end of the sub font file F₂, and so on) according to the order, thereby obtaining a usable font file F containing all glyph outline data.

Method 2: splitting the glyph outline data and data other than the glyph outline data in the font file, respectively.

The glyph outline data is the kernel of a font file and has the largest size in the font file. For example, in a TTF (True Type Font) font file, the glyph curve outline metadata glyf of the font file True Type Font (TTF) takes up 90% the size of the font file. Therefore, the glyph outline data and data other than the glyph outline data in the font file may be respectively processed in the following four cases.

In the first case, if the size of the glyph outline data in the font file is not lager than the transmission limit threshold, and the size of the data other than the glyph outline data in the font file is not larger than the transmission limit threshold, the font file may be split by the following two methods A and B.

Method A: the glyph outline data is taken as one sub font file and the data other than the glyph outline data is taken as another sub font file.

Accordingly, upon receipt of all of the split sub font files, the user device 20 combines all of the sub font files to obtain a usable font file including all glyph outline data.

Taking the TTF font file as an example, the TTF font file comprises 23 tables, such as head (font header), cmap (Character To Glyph Mapping), glyf (Glyph data), maxp (maximum profile), mmtx (Horizontal metrics), loca (index to location), name (Naming table), hmtx (horizontal metrics), kerm (kerning/intercharacter spacing), post (PostScript information) and so on, wherein the size of the glyph data glyf takes up 90% the size of the font file.

The glyph data corresponding to the glyf table is taken as the sub font file F₁, and the data of the tables other than glyf is taken as the sub font file F₂.

Method B: the glyph outline data is split into a plurality of sub font files each comprising a part of the glyph outline data; and for each of the sub font files, all data other than the glyph outline data in the font file is put into the sub font file, and the size of the sub font file is not larger than the transmission limit threshold.

Specifically, the split processing module 100 splits the glyph outline data into the sub font files F₁₁˜F₁ₙ (where n is a positive integer), and puts all data other than the glyph outline data into each of the sub font files F₁₁˜F₁ₙ, and the size of each of the sub font files F₁₁˜F₁ₙ is not larger than the transmission limit threshold. Each of the sub font files obtained with this method contains not only a part of the glyph outline data but also all of the data other than the glyph outline data. Each of the sub font files can therefore be used separately, which improves the flexibility in the use of the font file.

Accordingly, upon receipt of all split sub font files F₁₁˜F₁ₙ, the user device 20 may use each sub font file F₁₁˜F₁ₙ directly, it is just that each sub font file comprises only a part of the glyph outline data. All font files F₁₁˜F₁ₙ may also be combined to obtain the usable font file F comprising all glyph outline data.

In the second case, if the size of the glyph outline data in the font file is lager than the transmission limit threshold, and the size of the data other than the glyph outline data in the font file is not larger than the transmission limit threshold, the font file may be split by the following two methods C and D.

Method C: the font file is split into a plurality of sub font files each having a size no larger than the transmission limit threshold and comprising a part of the glyph outline data, and the data other than the glyph outline data is taken as a single sub font file.

Specifically, the split processing module 100 splits the glyph outline data into the sub font files F₁₁˜F₁ₙ according to the determined splitting unit, where n is a positive integer, and takes the data other than the glyph outline data as a single sub font file F₂.

Accordingly, upon receipt of all split sub font files F₁₁˜F₁ₙ and F₂, the user device 20 may combine the plurality of sub font files in the following two ways:

First, all split sub font files F₁₁˜F₁ₙ and F₂ are combined to obtain a usable font file F comprising all glyph outline data.

Alternatively, the sub font files F₁₁ and F₂ are combined to obtain a usable font file comprising a part of the glyph outline data; the sub font files F₁₂ and F₂ are combined to obtain a usable font file comprising a part the glyph outline data, and so on, thereby obtaining a plurality of usable font files each comprising only a part of the glyph outline data.

Method D: the font file is split into a plurality of sub font files each comprising a part of the glyph outline data; and for each of the sub font files, the data other than the glyph outline data in the font file is put into the sub font file, wherein the size of the sub font file is not larger than the transmission limit threshold.

Accordingly, upon receipt of all split sub font files F₁₁˜F₁ₙ, the user device 20 may use each sub font file F₁₁˜F₁ₙ directly, it is just that each sub font file comprises only a part of the glyph outline data. All font files F₁₁˜F₁ₙ may also be combined to obtain the usable font file F comprising all glyph outline data.

In the third case, if the size of the glyph outline data in the font file is lager than the transmission limit threshold, and the size of the data other than the glyph outline data in the font file is also larger than the transmission limit threshold, then the split process comprises: the glyph outline data in the font file is split into a plurality of sub font files each having a size no larger than the transmission limit threshold and comprising a part of the glyph outline data, and the data other than the glyph outline data is split into a plurality of sub font files each having a size no larger than the transmission limit threshold and comprising a part of the data other than the glyph outline data in the font file.

Specifically, the split processing module 100 splits, according to the determined splitting unit, the glyph outline data into a plurality of sub font files F₁₁˜F₁ₙ each comprising only a part of the glyph outline data, where n is a positive integer, and each sub font files F₁₁˜F₁ₙ is of a size no larger than the transmission limit threshold; and splits, according to the determined splitting unit, the data other than the glyph outline data into a plurality of sub font files F₂₁˜F₂ₘ each having a size no larger than the transmission limit threshold and comprising only a part of the data other than the glyph outline data, where m is a positive integer.

Accordingly, upon receipt of all split sub font files F₁₁˜F₁ₙ and F₂₁˜F₂ₘ, the user device 20 may combine the plurality of sub font files in the following two ways:

First, all split sub font files F₁₁˜F₁ₙ and F₂₁˜F₂ₘ are combined to obtain a usable font file F comprising all glyph outline data.

Alternatively, the sub font files F₁₁ and F₂₁˜F₂ₘ are combined to obtain a usable font file comprising a part the glyph outline data; the sub font files F₁₂ and F₂₁˜F₂ₘ are combined to obtain a usable font file comprising a part the glyph outline data, and so on, thereby obtaining a plurality of usable font files comprising only a part of the glyph outline data.

In the fourth case, if the size of the glyph outline data in the font file is not lager than the transmission limit threshold, and the size of the data other than the glyph outline data in the font file is larger than the transmission limit threshold, the splitting process comprises: the glyph outline data is taken as one sub font file and the data other than the glyph outline data is split into a plurality of sub font files each having a size no larger than the transmission limit threshold.

Specifically, the split processing module 100 takes the glyph outline data as one sub font file F₁ and splits, according to the determined splitting unit, the data other than the glyph outline data into a plurality of sub font files F₂₁˜F₂ₘ, where m is a positive integer.

Accordingly, upon receipt of all split sub font files F₁ and F₂₁˜F₂ₘ, the user device 20 combine all sub font files F₁ and F₂₁˜F₂ₘ, to obtain a usable font file comprising all glyph outline data.

When splitting the glyph outline data in the above methods of B, C and D, the splitting may be performed according to the international character encoding UNICODE corresponding to each glyph outline data. The splitting rules comprises but is not limited to: sequential splitting, such as taking 0X4E00˜0X4F00 as one group and putting them into the first sub font file, taking 0X4F01˜0X5001 as one group and putting them into the second sub font file, and so on, but it has to ensure that the size of each sub font file is not larger than the transmission limit threshold; the sequence order of the UNICODE character encoding is disrupted, for example, some glyph outline data with several UNICODE in the range of 0X4E00˜0X4F00 is randomly selected, and then some glyph outline data with several UNICODE in the range of 0X4F01˜0X5001 is randomly selected, so as to form the first sub font file, and then the second sub font file is formed by combining some glyph outline data with several UNICODE randomly selected from the unselected encodings, and so on, but it has to ensure that the size of each sub font file is not larger than the transmission limit threshold.

Please note, when performing the splitting, the splitting rules need to be transmitted to the user device, such that the user device may combine the sub font files according to the splitting rules to obtain the usable font file. To ensure a secure transmission, the splitting rules for the font file may be encrypted, such that even if other users embezzle the glyph outline data, they cannot use the font file as they cannot obtain the splitting rules.

When splitting the glyph outline data, the glyph outline data may also be split according to an ID serial number corresponding to each glyph outline data. The glyph outline data may also be split according to the Chinese national standard GBK/GB18030 corresponding to each glyph outline data, the splitting rule for which is similar to that of the UNICODE and will not be elaborated here.

Preferable, the split processing module 100 according to the embodiment of the present invention is further adapted for: creating an index file for the font file to be downloaded, according to the size of the font file to be downloaded and the transmission limit threshold of the gateway, and the index file comprises the size of the font file to be download, the splitting unit and the naming rules for the split sub font files.

Herein the size of the font file in the index file refers to the physical size in bytes (an integer) of the font file, the splitting unit refers to the size in bytes (an integer) of a sub font file obtained with a single splitting, wherein the splitting unit is not larger than the transmission limit threshold of the gateway. Please note that the size of the last sub font file may be smaller than the splitting unit, and sub font files other than the last sub font file are of a size equal to the splitting unit.

Please note that the index file may be created before or after the splitting.

Accordingly, the transmission module 101 is further adapted for transmitting the index file to the user device 20.

Accordingly, upon receipt of the index file transmitted by the server 10, the user device 20 reads the index file, determines a file name of each sub font file to be that needs to be downloaded according to the index file, and creates corresponding blank files for storing the sub font files downloaded from the server 10. During the procedure of downloading the sub font files, an offset amount of each sub font file starts from zero and a downloading offset amount of a currently being downloaded sub font file is recorded in real time.

As illustrated in FIG. 3, the server 10 according to an embodiment of the present invention further comprises: a determination module 102 for determining whether the size of the font file to be downloaded by the user device is larger than the transmission limit threshold of the gateway, and for causing the split processing module 100 to work, when the size of the font file is larger than the transmission limit threshold, and causing the transmission module 101 to transmit the font file directly to the user device 20, when the size of the font file is not larger than the transmission limit threshold.

Preferably, as illustrated in FIG. 3, for the purpose of reducing the size of the font file and improving the efficiency of the server, the server 10 according to an embodiment of the invention further comprises: a compression processing module 103 adapted for compressing the font file when the size of the font file is larger than the transmission limit threshold and before splitting the font file, and for causing the determination module 102 to work again after the compression processing.

The compression processing module 103 in accordance with an embodiment of the present invention may compress the font file with various compression algorithms known to those skilled in the art, such as the open source compression/decompression algorithms zip, winzip, 7-zip and the like. Compression ratios for different font files may be different; some font files may be compressed to 70% of the original size, while some other font files may only be compressed to 90% of the original size. However, for a wireless network, a small reduction in traffic may bring cost saving and improved download speed.

Accordingly, upon receipt of the plurality of sub font files split from the compressed font file, the user device 20 first processes all sub font files to obtain a usable compressed font file, and then decompresses the compressed font file to obtain the usable font file. Of course, if the size of the font file compressed by the compression processing module 103 is not larger than the transmission limit threshold, the split processing module 100 does not split the compressed font file and the transmission module 101 transmits the compressed font file to the user device 20. In this case, the user device 20 receives the compressed font file and decompresses the compressed font file to obtain the usable font file.

Base on the same inventive concept, an embodiment of the present invention further provides a method for downloading a font file. Implementations of the method may refer to the implementations of the server of FIG. 2, as the principle of solving the problem by the method is the same as the server illustrated in FIG. 2. The same parts of which will not be elaborated.

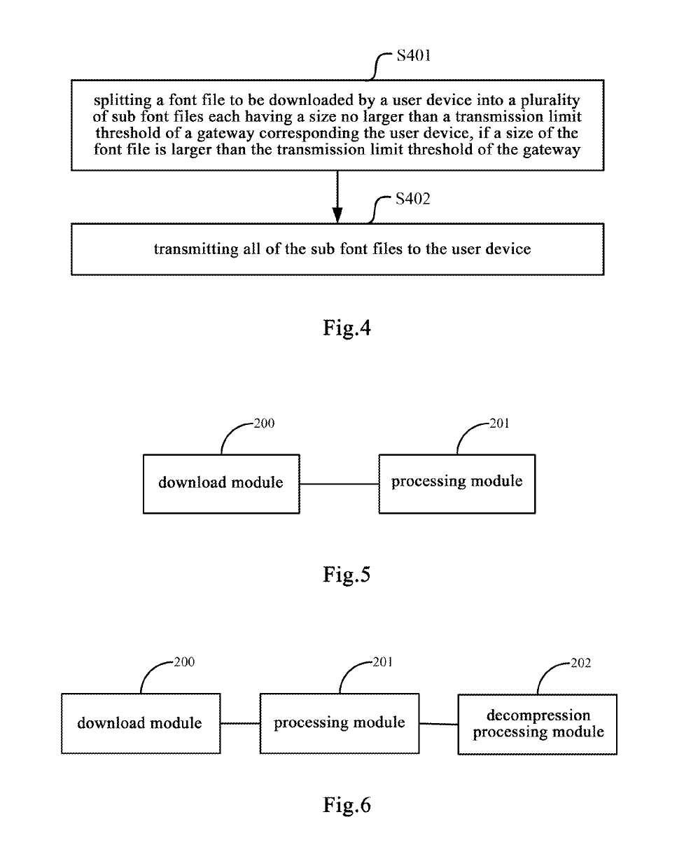

An embodiment of the present invention provides a method for downloading a font file as illustrated in FIG. 4, the method comprises the steps of: S401, splitting a font file to be downloaded by a user device into a plurality of sub font files each having a size no larger than a transmission limit threshold of a gateway corresponding the user device, if a size of the font file is larger than the transmission limit threshold of the gateway; and S402, transmitting all of the sub font files to the user device.

Preferably, splitting the font file in S401 comprises: splitting glyph outline data of the font file to obtain the plurality of sub font files each comprising a part of the glyph outline data and having a size no larger than the transmission limit threshold, if a size of the glyph outline data is larger than the transmission limit threshold; splitting data other than the glyph outline data in the font file to obtain the plurality of sub font files each comprising a part of the data other than the glyph outline data and having a size no larger than the transmission limit threshold, when a size of the data other than the glyph outline data is larger than the transmission limit threshold; and taking the data other than the glyph outline data in the font file as a single sub font file if a size of the data other than the glyph outline data is not larger than the transmission limit threshold.

Preferably, splitting the font file in S401 comprises: splitting glyph outline data in the font file to obtain a plurality of the sub font files each comprising a part of the glyph outline data, if a size of data other than the glyph outline data in the font file is not larger than the transmission limit threshold; and for each sub font file of the above sub font files, putting all data other than the glyph outline data into the sub font file, wherein a size of the sub font file is not larger than the transmission limit threshold.

As illustrated in FIG. 5, the user device 20 in accordance with an embodiment of the invention comprises: a download module 200 for downloading all of the sub font files; and a processing module 201 for processing all of the sub font files to obtain a usable font file.

Herein, the processing module 201 is adapted for: combining all sub font files each comprising the part of the glyph outline data and all sub font files comprising data other than the glyph outline data to obtain a usable font file, if the sub font files each comprising the part of the glyph outline data do not comprise the data other than the glyph outline data; or for each sub font file comprising the part of glyph outline data, combining the sub font file with all sub font files comprising data other than the glyph outline data to obtain a single usable font file, if the sub font files each comprising the part of glyph outline data do not comprise the data other than the glyph outline data.

Preferably, the processing module 201 is adapted for: taking each of the downloaded sub font files as a usable font file, if the sub font file comprising the glyph outline data comprises all data other than the glyph outline data.

During the procedure of downloading the sub font files by the user device 20, if a connection with the server 10 is disconnected and downloading continues after a normal connection with the server 10 is recovered, the user device 20 first obtains a total size of the locally downloaded sub font files, and then carries out calculations based on the total size and the splitting unit of the font file to be downloaded to set the sub font files to be downloaded subsequently, and transmits a request for renewing downloading to the server 10 thereby resuming the downloading.

Specifically, the user device 20 firstly reads the index file for the font file to be downloaded to determine the size and the splitting unit of the font file and sequentially determines a size of each of the downloaded sub font files to determine whether the downloaded sub font files are complete.

For each of the downloaded sub font files, if the size of the sub font file is not zero and the size of the sub font file is the same as an actual size of the corresponding sub font file in the server 10, it is determined that the sub font file has been downloaded completely.

If the size of the sub font file is smaller than the actual size of the corresponding sub font file in the server 10, a pointer for the corresponding sub font file in the server 10 is offset by an amount corresponding to the size of the sub font file which has been downloaded by the user device 20, a remaining size of the sub font file to be downloaded is a difference between the actual size of the sub font file in the server 10 and the locally downloaded size of the sub font file.

To ensure the security of the resumed transmission, after the normal connection is recovered, the user device 20 does not record the amount of the downloaded data in the program, instead, the user device 20 reads the size of the downloaded sub font files directly in the stored sub font files, then the size of the sub font file is used as an initial location for the new download request, and the downloaded segment size is the same as the set size.

Preferably, the server 10 according to the embodiment of the present invention compresses the font file. Accordingly, the user device 20 as illustrated in FIG. 6 further comprises: a decompression processing module 202 for decompressing the compressed font file to obtain the usable font file, after processing all sub font files.

Base on the same inventive concept, an embodiment of the invention further provides a method for downloading a font file. Implementations of the method may refer to the implementations of the server of FIG. 5, as the principle of solving the problem by the method is the same as the server illustrated in FIG. 5; the same parts of which will not be elaborated.

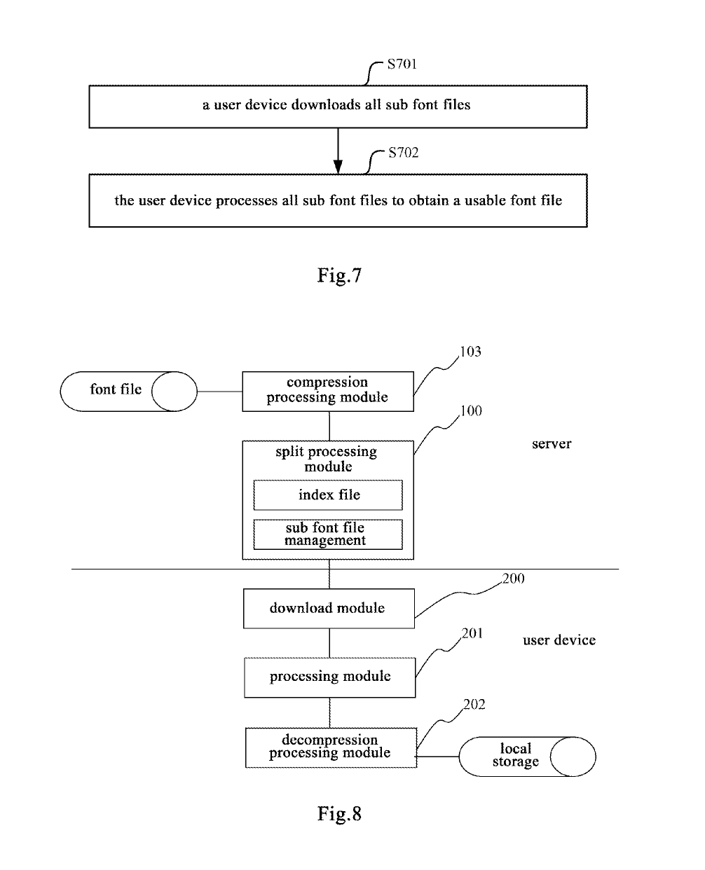

The embodiment of the present invention provides a method for downloading a font file as illustrated in FIG. 7, the method comprises: S701: a user device downloads all sub font files; and S702: the user device processes all sub font files to obtain a usable font file.

Herein, processing all sub font files in S702 comprises: if the sub font files each comprising a part of the glyph outline data do not comprise data other than the glyph outline data, combining all sub font files comprising the part of the glyph outline data and all sub font files comprising the data other than the glyph outline data to obtain a usable font file; or if the sub font files each comprising a part of the glyph outline data do not comprise data other than the glyph outline data, for each of the sub font files each comprising the part of glyph outline data, combining the sub font file with all sub font files comprising the data other than the glyph outline data to obtain a single usable font file.

Preferably, processing all sub font files in S702 comprises: if a sub font file comprising the glyph outline data comprises all data other than the glyph outline data, taking each of the downloaded sub font files as a single usable font file.

In the following, a system for downloading a font file according to an embodiment of the present invention will be described in detail with reference to FIG. 8.

As illustrated in FIG. 8, the compression processing module 103 at the server end compresses a font file to be downloaded with a size larger than the transmission limit threshold; the split processing module 100 at the server end splits the compressed font file into a plurality of sub font files and transmits the plurality of sub font files to the user device end.

The download module 200 at the user device end downloads all sub font files from the server end. The processing module 201 at the user device end processes all downloaded sub font files to obtain a usable compressed font file. The decompression processing module 202 at the user device end decompresses the obtained font file to obtain the usable font file.

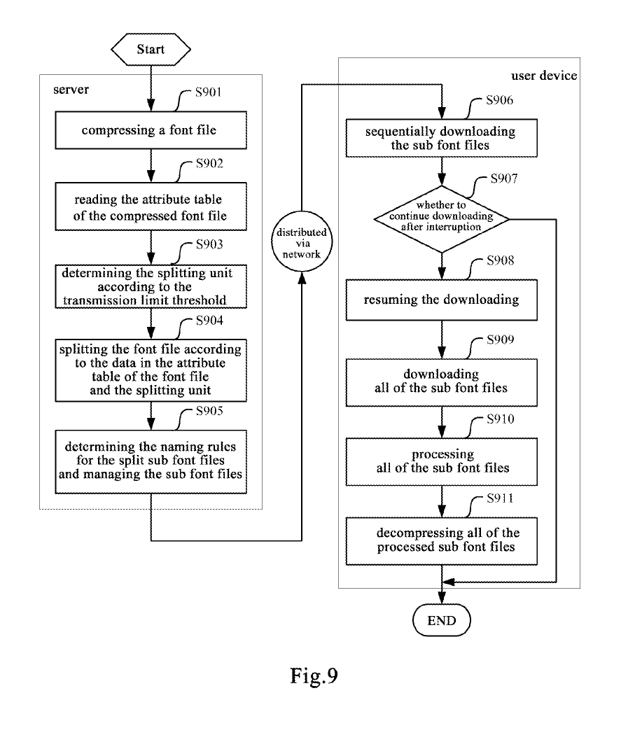

In the following, the method for downloading the font file according to the embodiment of the present invention will be described in detail with reference to FIG. 9.

As illustrated in FIG. 9, the method for downloading the font file according to the embodiment of the present invention comprises the steps of:

S901: the server compresses a font file to be downloaded with a size larger than the transmission limit threshold;

S902: the server reads the attribute table of the compressed font file, which comprises the size of the font file;

S903: the server determines the splitting unit according to the transmission limit threshold;

S904: the server splits the font file according to the data in the attribute table of the compressed font file and the splitting unit;

S905: the server determines the naming rules for the split sub font files and manages the sub font files, and transmits all of the determined sub font files to the user device via the network; wherein managing the sub font files comprises: determining the uniqueness of actual name of each sub font file, recording the correspondence relationship between the actual name and the splitting rule of the sub font file, so as to prevent the sub font files subjected to multiple-splitting from overwriting each other, and recording match/combination relationship between attributes of each sub font file and attributes of other sub font files, and so on.

S906: the sub font files are sequentially downloaded;

S907: if an interruption occurs, whether to continue downloading after the interruption is determined;

If yes, it proceeds to S908;

Otherwise, the flow is ended.

S908: the downloading is resumed;

S909: all of the sub font files are downloaded;

S910: all of the sub font files are processed;

S911: all of the processed sub font files are decompressed to obtain the usable font file, and the flow is ended.

While the preferred embodiments of the present invention have been described, once a person skilled in the art appreciates the basic inventive concept herein, additional variations and modifications may be made to these embodiments. Therefore, the following claims intend to be interpreted to include preferred embodiments and all variations and modifications within the scope of the present invention.

According to the embodiments of the present invention, when the size of the font file to be downloaded is larger than the transmission limit threshold of the gateway corresponding to the user device, the font file is split into a plurality of sub font files each having a size no larger than the transmission limit threshold. When being downloaded by the user device, each sub font file is downloaded and then processed to obtain the usable font file. It thus avoids the situation that the user cannot download the font file to be downloaded from the file server when the size of the font file exceeds the limit of the gateway corresponding to the user. Meanwhile, the download speed is increased, which improves user experience.

According to the embodiments of the present invention, when the size of the font file to be downloaded is larger than the transmission limit threshold of the gateway corresponding to the user device, and the size of the data other than the glyph outline data is not larger than the transmission limit threshold, the glyph outline data in the font file may be split into a plurality of sub font files each comprising a part of the glyph outline data, and all of the data other than the glyph outline data is put into each of the sub font files. The sub font files thus obtained may be used directly, which improves the flexibility in the use of the font file.

According to the embodiments of the present invention, if the split sub font files need to be prevented from being used by other user devices, each sub font file may be encrypted (e.g. by parity check, shift transform and so on) during the process of splitting the font files. After being downloaded, all sub font files have to be decrypted first and then processed to obtain the usable font file.

Obviously, various modifications and variations may be made by the person skilled in the art without departing from the spirit and scope of the present invention. As such, if these modifications and variations of the present invention come within the scope of the claims and their equivalents, the present invention intends to cover such modifications and variations.

1. A method for downloading a font file, comprising:
splitting a font file to be downloaded by a user device into a plurality of sub font files each having a size no larger than a transmission limit threshold of a gateway corresponding the user device, if a size of the font file is larger than the transmission limit threshold of the gateway; and
transmitting all of the sub font files to the user device.

2. The method of claim 1, wherein splitting the font file comprises:
splitting glyph outline data of the font file to obtain the plurality of sub font files each comprising a part of the glyph outline data and having a size no larger than the transmission limit threshold, if a size of the glyph outline data is larger than the transmission limit threshold; and
splitting data other than the glyph outline data in the font file to obtain the plurality of sub font files each comprising a part of the data other than the glyph outline data and having a size no larger than the transmission limit threshold, if a size of the data other than the glyph outline data is larger than the transmission limit threshold; taking data other than the glyph outline data in the font file as a single sub font file if a size of the data other than the glyph outline data is not larger than the transmission limit threshold.

3. The method of claim 1, wherein splitting the font file comprises:
splitting glyph outline data in the font file to obtain the plurality of sub font files each comprising a part of the glyph outline data, if a size of data other than the glyph outline data in the font file is no larger than the transmission limit threshold; and
for each sub font file of the above sub font files, putting all data other than the glyph outline data into the sub font file, wherein a size of the sub font file is not larger than the transmission limit threshold.

4. The method of claim 1, further comprising:
downloading all of the sub font files to the user device; and
processing all of the sub font files by the user device to obtain a usable font file.

5. The method of claim 4, wherein processing all of the sub font files by the user device comprises:
combining all sub font files each comprising a part of glyph outline data and all sub font files comprising data other than the glyph outline data to obtain the usable font file, if the sub font files each comprising the part of glyph outline data do not comprise the data other than the glyph outline data; or
for each sub font file comprising a part of glyph outline data, combining the sub font file with all sub font files comprising data other than the glyph outline data to obtain the usable font file, if the sub font files each comprising the part of glyph outline data do not comprise the data other than the glyph outline data.

6. The method of claim 4, wherein processing all of the sub font files by the user device comprises:
taking each of the downloaded sub font files as a single usable font file, if the sub font file comprising glyph outline data comprises all data other than the glyph outline data.

7. A system for downloading a font file, comprising:
a server for splitting a font file to be downloaded by a user device into a plurality of sub font files each having a size no larger than a transmission limit threshold of a gateway corresponding the user device, when a size of the font file is larger than the transmission limit threshold of the gateway; and transmitting all of the sub font files to the user device; and
the user device for downloading all of the sub font files, and processing all of the sub font files to obtain a usable font file.

8. The system of claim 7, wherein,
the user device is further adapted for transmitting a download request to the sever via the corresponding gateway to obtain the font file to be downloaded; and
the server is further adapted for, upon receipt of the download request transmitted by the user device, determining the gateway corresponding to the user device according to ID information of the user device, thereby determining the transmission limit threshold of the gateway; and for determining the font file to be downloaded according to the download request transmitted by the user device, and determining whether to split the font file according to a relationship between the size of the font file and the transmission limit threshold.

9. (canceled)

10. The system of claim 7, wherein the server comprises:
a split processing module for splitting the font file to be downloaded by the user device into the plurality of sub font files each having a size no larger than the transmission limit threshold of the gateway corresponding the user device, when the size of the font file is larger than the transmission limit threshold of the gateway; and
a transmission module for transmitting all of the sub font files to the user device.

11. The system of claim 10, wherein the split processing module is adapted for:
determining a splitting unit of the font file to be downloaded according to the transmission limit threshold of the gateway corresponding to the user device when the size of the font file to be downloaded is larger than the transmission limit threshold, and splitting the font file according to the splitting unit to obtain a plurality of sub font files each having a size no larger than the transmission limit threshold, wherein the splitting unit is a size of a sub font file obtained with a single splitting and a size of the splitting unit is not larger than the transmission limit threshold.

12. The system of claim 11, wherein the split processing module is further adapted for determining a number of the sub font files according to the splitting unit and for creating a plurality of blank files, and sequentially copying data in the font file to a corresponding one of the plurality of blank files according to the size of the splitting unit, thereby obtaining the plurality of sub font files each having a size no larger than the transmission limit threshold, wherein a number of the blank files is the same as the number of the sub font files.

13. The system of claim 11, wherein the split processing module is further adapted for sequentially splitting the data in the font file according to the size of the splitting unit to obtain the plurality of sub font files each having a size no larger than the transmission limit threshold, without retaining the font file.

14. The system of claim 11, wherein,
the split processing module is further adapted for determining naming rules for the sub font files;
the transmission module is further adapted for transmitting the naming rules for the sub font files to the user device; and
the user device is further adapted for, after downloading all of the sub font files and the naming rules for the sub font files, determining an order for all of the sub font files according to the naming rules for the sub font files, and combining all of the sub font files in a manner that a next sub font file is appended to the end of a previous font file one by one according to the order, thereby obtaining the usable font file.

15. The system of claim 11, wherein,
the split processing module is further adapted for determining naming rules for the sub font files and for creating an index file for the font file to be downloaded, the index file comprises the size of the font file, the splitting unit and the naming rules for the sub font files;
the transmission module is further adapted for transmitting the index file to the user device; and
the user device is further adapted for, after downloading all of the sub font files and the index file, determining a file name of each sub font file to be that needs to be downloaded according to the index file, and creating corresponding blank files for sequentially storing the sub font files downloaded from the transmission module; during the procedure of downloading the sub font files, an offset amount of each sub font file starts from zero and a downloading offset amount of a currently being downloaded sub font file is recorded in real time, so as to facilitate combining the sub font files to obtain the usable font file.

16. The system of claim 15, wherein the user device is further adapted for:
during the procedure of downloading the sub font files, if a connection with the server is disconnected and downloading needs to continue after a normal connection with the server is recovered, first obtaining a total size of the downloaded sub font files, and then carrying out calculations based on the total size of the downloaded sub font files and the splitting unit of the font file to be downloaded to set the sub font files to be downloaded subsequently, and transmitting a request for renewing downloading thereby resuming the downloading.

17. The system of claim 16, wherein the user device is further adapted for:
reading the index file for the font file to be downloaded to determine the size and the splitting unit of the font file and sequentially determining a size of each of the downloaded sub font files to determine whether the downloaded sub font files are complete;
for each of the downloaded sub font files, determining that the sub font file has been downloaded completely, if the size of the sub font file is not zero and the size of the sub font file is the same as an actual size of the corresponding sub font file in the server; and
offsetting a pointer for the corresponding sub font file in the server by an amount corresponding to the size of the sub font file has been downloaded by the user device, if the size of the sub font file is smaller than the actual size of the corresponding sub font file in the server, a remaining size of the sub font file to be downloaded is a difference between the actual size of the corresponding sub font file in the server and the locally downloaded size of the sub font file.

18. The system of claim 10, wherein the split processing module is adapted for:
when the size of the font file to be downloaded by the user device is larger than the transmission limit threshold of the gateway corresponding to the user device,
if the size of the glyph outline data in the font file is not larger than the transmission limit threshold, and the size of the data other than the glyph outline data in the font file is not larger than the transmission limit threshold,
splitting the font file to obtain a single sub font file comprising the glyph outline data in the font file and a single sub font file comprising the data other than the glyph outline data in the font file, or
splitting the font file to obtain a plurality of sub font files each comprising a part of the glyph outline data in the font file and the data other than the glyph outline data in the font file;
if the size of the glyph outline data in the font file is larger than the transmission limit threshold, and the size of the data other than the glyph outline data in the font file is not larger than the transmission limit threshold,
splitting the font file to obtain a single sub font file comprising the data other than the glyph outline data in the font file and a plurality of sub font files each having a size no larger than the transmission limit threshold and comprising a part of the glyph outline data in the font file, or
splitting the font file to obtain a plurality of sub font files each having a size no larger than the transmission limit threshold and comprising a part of the glyph outline data in the font file and the data other than the glyph outline data in the font file;
if the size of the glyph outline data in the font file is larger than the transmission limit threshold, and the size of the data other than the glyph outline data in the font file is also larger than the transmission limit threshold, then
splitting the font file to obtain a plurality of sub font files each having a size no larger than the transmission limit threshold and comprising a part of the glyph outline data in the font file and a plurality of sub font files each having a size no larger than the transmission limit threshold and comprising a part of the data other than the glyph outline data in the font file; and
if the size of the glyph outline data in the font file is not larger than the transmission limit threshold, and the size of the data other than the glyph outline data in the font file is larger than the transmission limit threshold, then splitting the font file to obtain a single sub font file comprising the glyph outline data in the font file and a plurality of sub font files each having a size no larger than the transmission limit threshold and comprising a part of the data other than the glyph outline data in the font file.

19. The system of claim 18, wherein,
the split processing module is further adapted for, when splitting the font file to obtain the sub font files each comprising the part of the glyph outline data in the font file, splitting the glyph outline data in the font file according to international Character encoding, ID serial number or Chinese national standard corresponding to each glyph outline data and establishing the splitting rules;
the transmission module is further adapted for transmitting the splitting rules to the user device; and
the user device is further adapted for combining all of the sub font files according the splitting rules to obtain the usable font file, after downloading all of the sub font files.

20. The system of claim 18, wherein the user device comprises:
a downloading module for downloading all of the sub font files; and
a processing module for processing all of the sub font files to obtain the usable font file.

21. The system of claim 20, wherein the processing module is adapted for:
if a sub font file comprising the part of glyph outline data does not comprise data other than the glyph outline data,
combining all of the sub font files each comprising the part of the glyph outline data and all of the sub font files comprising the data other than the glyph outline data to obtain the usable font file; or
for each of the sub font files each comprising the part of glyph outline data, combining the sub font file with all of the sub font files comprising the data other than the glyph outline data to obtain a single usable font file; and
if a sub font file comprising the glyph outline data comprises all data other than the glyph outline data, taking each of the downloaded sub font files as a single usable font file.

22. The system of claim 10, wherein the server further comprises:
a determination module for determining whether the size of the font file to be downloaded by the user device is larger than the transmission limit threshold of the gateway corresponding to the user device,
the determination module causes the split processing module to work, when the size of the font file is larger than the transmission limit threshold; and
the determination module causes the transmission module to transmit the font file directly to the user device, when the size of the font file is no larger than the transmission limit threshold.

23. The system of claim 22, wherein the server further comprises a compression processing module,
the compression processing module is adapted for compressing the font file when the determination module determines that the size of the font file is larger than the transmission limit threshold and before the determination module causes the split processing module to work, and for causing the determination module to work again after the compression processing;
the determination module is further adapted for determining once again whether the size of the compressed font file is larger than the transmission limit threshold of the gateway corresponding to the user device, after being caused to work by the compression processing module, and for causing the split processing module to work, when the size of the compressed font file is larger than the transmission limit threshold; and causing the transmission module to transmit the compressed font file directly to the user device, when the size of the compressed font file is not larger than the transmission limit threshold; and
the user device is further adapted for, after downloading all of the sub font files, processing all of the sub font files to obtain a usable compressed font file; the user device comprises a decompression processing module, which is adapted for decompressing the compressed font file to obtain the usable font file.
